(19) United States
(12) Patent Application Publication
(10) Pub. No.: US 2022/0098916 A1
(43) Pub. Date: Mar. 31, 2022

(54) DOOR DRIVE DEVICE CONTROLLABLE FOR DETECTING A USER ACTION ON A VEHICLE DOOR

(71) Applicant: Brose Fahrzeugteile SE & Co. Kommanditgesellschaft, Bamberg, Bamberg (DE)

(72) Inventor: Takafumi EGUCHI, Aichi (JP)

(73) Assignee: Brose Fahrzeugteile SE & Co. Kommanditgesellschaft, Bamberg, Bamberg (DE)

(21) Appl. No.: 17/425,442

(22) PCT Filed: Feb. 1, 2019
(86) PCT No.: PCT/EP2019/052532

§ 371 Date: Jul. 23, 2021

(51) Int. Cl. E05F 15/627

(52) U.S. Cl. CPC E05F 15/627; E05Y 2201/234; E05Y 2201/216; E05Y 2900/531; E05Y 2400/44; E05Y 2800/113; E05Y 2201/654

(57) ABSTRACT

A door drive device for adjusting and/or locking a vehicle door relative to a vehicle body includes an adjustment member and a drive element operatively coupled to the adjustment member. A sensor is configured to measure movement of the vehicle door and/or a force acting onto the vehicle door and to output a sensor signal. A control device is configured to control operation of the door drive device and is programmed to detect an action onto the vehicle door indicative of a user command for moving the vehicle door based on the sensor signal, and conclude for an action onto the vehicle door indicative of a user command for moving the vehicle door by evaluating a characteristic value derived from the sensor signal based on a decision parameter, wherein the decision parameter is variable depending on a movement direction of the vehicle door.

### CROSS-REFERENCE TO RELATED APPLICATIONS

This application is the U.S. National Phase of PCT Application No. PCT/EP2019/052532 filed Feb. 1, 2019, the disclosure of which is hereby incorporated in its entirety by reference herein.

### TECHNICAL FIELD

This application relates to a door drive device.

### BACKGROUND

A door drive device, as disclosed for example in WO 2018/002158 A1, includes an adjustment member in the shape of a retaining strap coupled, for example, to the vehicle body and operatively connected to a drive element in the shape of a cable drum. The coupling of the adjustment member to the drive element is established by a coupling element in the shape of a pull cable, which is wound around the cable drum and by means of which the cable drum can be moved with respect to the adjustment member in order to cause a movement of the vehicle door with respect to the vehicle body. A drive device is coupled to the drive element by a gearing and a coupling device. The coupling device is designed such that, in a coupling state, a coupling of the drive device to the drive element is established, and, in an uncoupling state, free pivoting movement of the vehicle door with respect to the vehicle body is possible. In a brake state of the coupling device, a movement of the drive element and the vehicle door with respect to the vehicle body is braked, such that, for example, a manual movement of the vehicle door can be controlled.

### SUMMARY

Disclosed is a door device and a method for operating a door device that may provide an improve a user experience for initiating a manual movement of a vehicle door.

A control device is configured to conclude for an action onto the vehicle door indicative of a user command for moving the vehicle door by evaluating a characteristic value derived from the sensor signal based on a decision parameter, wherein the decision parameter is variable depending on a movement direction of the vehicle door.

Generally, the control device may be configured to control the drive device to allow free pivoting of the vehicle door in case a user command for initiating a movement of the vehicle door is detected. For detecting such user action, the control device evaluates the sensor signal provided by the sensor device in order to derive a characteristic value from the sensor signal. This characteristic value is evaluated, for example, by comparing the characteristic value to the decision parameter, in order to decide whether a user action is taking place for initiating a movement of the vehicle door from a currently assumed, opened or partially opened position, or not.

The decision parameter is variable depending on the desired movement direction of the vehicle door. If it is detected that a user acts onto the vehicle door for closing the vehicle door, a different decision parameter is applied than when it is detected that a user acts onto the vehicle door for opening the vehicle door. By using different decision parameters depending on the movement direction of the vehicle door, it is possible to decide whether a user wishes to move the vehicle door in a way that the user obtains the impression of a more uniform behavior of the system. In particular, by adjusting the decision parameter to use different decision parameters dependent on the movement direction of the vehicle door, effects for example due to external forces acting onto the vehicle door may be taken into account, for example, due to gravity causing a pretensioning of the vehicle door towards the closed position or the opened position.

In one embodiment, the control device is configured to derive from the sensor signal, as the characteristic value, an information indicative of at least one of the position of the vehicle door, a movement speed of the vehicle door, an acceleration of the vehicle door and a force acting onto the vehicle door.

The sensor device may, for example, be a sensor for detecting movement of a component of the drive device, such as a rotation of a rotatable shaft of the drive device. From the movement of the component of the drive device it can be derived at what speed the vehicle door is moved and which position the vehicle door currently assumes. In addition, an information relating to the acceleration of the vehicle door can be derived.

The sensor device may, in this case, for example, comprise one or multiple Hall sensors suitable for sensing position in a relative manner. Alternatively, the sensor device may comprise, for example, a magnetic disk attached to the drive shaft such that an absolute detection of position of the drive shaft is possible.

In addition or alternatively, the sensor device may be a speed sensor in the form of a gyrometer placed on the vehicle door for measuring the angular velocity of the vehicle door.

In addition or alternatively, the sensor device may be an accelerometer placed on the vehicle door for measuring an acceleration of the vehicle door.

In addition or alternatively, the sensor device may be a force sensor configured to measure a force acting in between the vehicle door and the vehicle door body, for example according to a deformation of a component of the door drive device due to a loading of the vehicle door with respect to the vehicle body.

In each case, the sensor device provides a sensor signal that the control device evaluates in order to derive a characteristic value from the sensor signal. By comparing the characteristic value to the decision parameter, it is decided whether a user acts onto the vehicle door and likely wishes to move the vehicle door. Based on such evaluation, the control device may, for example, issue a control command to control the drive device such that the user is enabled to freely and manually pivot the vehicle door with respect to the vehicle body.

The decision parameter may, for example, be a threshold parameter. If the characteristic value relates to the position of the vehicle door, it for example may be determined whether the vehicle door, out of its currently assumed position, has been moved by a distance larger than a threshold distance defined by the decision parameter. If this is the case, it may be assumed that a user action on the vehicle door is present. If, in contrast, the characteristic value relates to the angular velocity or an acceleration of the vehicle door, the characteristic value may be compared to a velocity threshold or an acceleration threshold defined by the decision parameter in order to conclude whether a user action on the vehicle door is present. If, in contrast, the characteristic value relates to a force applied to the vehicle door, the characteristic value may be compared to a force threshold defined by the decision parameter in order to conclude for a user action onto the vehicle door if the determined force exceeds the force threshold.

It also is conceivable to apply several conditions for concluding for a user action to move the vehicle door, for example, by comparing a position information to a position threshold and a speed or acceleration information to a speed or acceleration threshold.

The decision parameter may be different depending on the movement speed of the vehicle door. For example, to conclude for a user action onto the vehicle door a threshold distance may be assumed larger in the closing direction than in the opening direction. Accordingly, in one embodiment, the control device is configured to set the decision parameter to a first value for an opening movement of the vehicle door and to a second value different from the first value for a closing movement of the vehicle door.

In one embodiment, the control device is configured to adjust the decision parameter based on at least one further sensor input from another sensor device. This is based on the finding that conditions of a vehicle, for example, a parking position of the vehicle, generally have an influence on the behavior of the door system and pretensioning forces acting onto the vehicle door. If, hence, for example an inclination sensor of the vehicle detects that the vehicle is parked at an inclined position, it may be (approximately) determined what gravity forces act onto the vehicle door, in particular by taking the (known) mass of the vehicle door and its connection to the vehicle body into account. Hence, from the sensor signal of the additional sensor it may be derived what gravity force acts onto the vehicle door, in order to adjust the decision parameter based on the determined gravity force. In particular, if it is found that large gravity forces act onto the vehicle door, the difference between the decision parameter to be used for a movement of the vehicle door in the closing direction versus the decision parameter to be used for a movement of the vehicle door in the opening direction may be large.

In one embodiment, the additional sensor device may be configured to detect the presence of an object in a path of movement of the vehicle door. Such sensor device may, for example, be a proximity sensor or a monitoring sensor such as a radar or lidar system. If it is found that a foreign object is present in the path of movement of the vehicle door in the opening or closing direction the decision parameter may be increased in order to prevent a movement of the vehicle door towards the foreign object, such that a pinching situation is preventively avoided.

The vehicle door may be held fixed in a currently assumed (opened) position, for example, by a brake device acting onto a gearing element (e.g., the drive element), such that by means of the brake device a movement of the gear element may be braked. In this case a drive device may be permanently coupled to a drive train. For allowing a free pivoting movement of the vehicle door, the brake device is switched to a non-braking state.

Alternatively, a coupling device may serve to couple a drive element to a drive train, the brake device being switchable between a coupling state, a brake state, and a free state. In the coupling state the vehicle door in this case is fixedly held in position (in case an electric drive is not energized) by a self-locking of the electric drive. For allowing a free pivoting movement of the vehicle door, the coupling device is switched to the free state.

Alternatively, an electromotive drive device may electrically be controlled to fix a vehicle door, without requiring a brake device. For allowing a free pivoting movement of the vehicle door, the electrical control may be terminated such that a pivoting of the vehicle door becomes possible.

In one embodiment, the door drive device includes a coupling device operatively connected to the drive element, wherein the coupling device is transferable between a coupling state for establishing a force flow, via the drive element and the adjustment member, between the vehicle door and the vehicle body and an uncoupling state for allowing free pivoting of the vehicle door with respect to the vehicle body.

In one embodiment, the coupling device includes coupling elements which, in the coupling state, are in frictional connection with each other and in the uncoupling state are released from one another. The coupling elements serve to establish the force flow in between the vehicle door and the vehicle body and, in the coupling state, are operatively connected to each other in a torque-proof manner such that forces may be transferred from one coupling element to the other and hence between the vehicle door and the vehicle body.

The coupling device may, for example, have the shape of a drum brake or a lamella brake, the coupling device being transferable between different states, such as the coupling state, the uncoupling state and, potentially, an additional brake state in order to brake a movement of the vehicle door with respect to the vehicle body.

The coupling device may, for example, be a drum brake device. An example drum brake device is described in Applicant's application WO 2018/002158 A1. The coupling device may, however, also be designed in a different manner, for example, as a lamella brake, a magnetic brake or the like.

In one embodiment, the coupling elements of the coupling device in the coupling state of the coupling device are frictionally movable with respect to each other if a torque larger than a maximum holding torque is applied in between the coupling elements. Hence, in the coupling state the coupling elements are pressed into abutment with one another with a predefined force such that a predefined maximum holding torque is provided by means of the coupling device. If a torque applied to the coupling device exceeds the maximum holding torque the coupling elements are rotationally movable with respect to each other under dynamic friction, such that the vehicle door can be moved with respect to the vehicle body if the maximum holding torque is exceeded.

Herein, in one embodiment, the control device may be configured to control the coupling device for adjusting the maximum holding torque. Hence, the maximum holding torque provided by the coupling device may be altered in that the forces by means of which the coupling elements are pressed into operative, frictional abutment with one another are modified. For example, if a foreign object in the movement path of the vehicle door is detected by means of a suitable sensor device the maximum holding torque may be increased such that a movement of the vehicle door towards the foreign object is prevented. In addition, dependent, for example, on a gravity force acting onto the vehicle door, the maximum holding torque may be adjusted in order to provide for a reliable locking of the vehicle door in a currently assumed position.

In another embodiment, the maximum holding torque may be adjusted dependent on a voltage level of a supply voltage source, such as a vehicle energy system (battery). This is based on the finding that in case of a low supply voltage a function to switch the coupling device from its coupling state to its uncoupling state for allowing a free pivoting of the vehicle door may not be available. If this is the case and the door is opened and fixed by the coupling device in an opened position, a manual closing may not be easily possible because the coupling device may not be switched into its uncoupling state. Hence, if the control device detects a low supply voltage, the maximum holding torque provided by the coupling device may be adjusted to a lower value such that, in case a failure of the switching function of the coupling device arises, the user may close the vehicle door despite the coupling device being in its coupling state.

In one embodiment, the door drive device includes an electric drive motor for driving the drive element, wherein the coupling device is operative to, in the coupling state, operatively couple the drive motor to the drive element and, in the uncoupling state, operatively decouple the drive motor from the drive element. The door drive device hence is configured as an electromotive drive device for electromotively moving the vehicle door. For this, the drive motor, in the coupling state, may transfer adjusting forces to the drive element and into the adjustment element in order to move the vehicle door with respect to the vehicle body. In the uncoupling state, a manual movement of the vehicle door independent of the electric drive motor is possible.

An assembly of a vehicle including a vehicle door, a vehicle body, and a door drive device of the kind described above for adjusting and/or locking the vehicle door relative to the vehicle body.

A method for operating the door drive device for adjusting and/or locking a vehicle door relative to a vehicle body may include moving an adjustment member with respect to a drive element for moving the vehicle door relative to the vehicle body; measuring, using a sensor device, a measuring quantity indicative of a movement of the vehicle door to provide a sensor signal; and controlling, using a control device, operation of the door drive device, wherein the control device is configured to detect, based on the sensor signal, an action onto the vehicle door indicative of a user command for moving the vehicle door. The control device concludes for an action onto the vehicle door indicative of a user command for moving the vehicle door by evaluating a characteristic value derived from the sensor signal based on a decision parameter, wherein the decision parameter is variable depending on a movement direction of the vehicle door.

The advantages and advantageous embodiments described above for the door drive device equally apply also to the method, such that it shall be referred to the above.

### BRIEF DESCRIPTION OF THE DRAWINGS

FIG. 1 shows a schematic view of a vehicle door on a vehicle body;

FIG. 2 shows a schematic view of a door drive device having a drive motor, a coupling device, a control device, and an adjustment member for moving the vehicle door;

FIG. 3 shows a view of an embodiment of a door drive device for moving a vehicle door;

FIG. 4 shows a view of a sub-assembly of the door drive device;

FIG. 5 shows a view of a drive motor, a gearbox and a coupling device of the door drive device;

FIG. 6 shows a schematic view of a vehicle having a vehicle body and a vehicle door arranged thereon;

FIG. 7 shows a schematic view of a vehicle door on a vehicle body, when applying a manual force for moving the vehicle door towards a closed position;

FIG. 8 shows a schematic view of the vehicle body and the vehicle door, when applying a manual force onto the vehicle door towards in opened position;

FIG. 9 shows a graph indicating a manual force applied to a vehicle door and a corresponding position of the vehicle door, in case of an opening movement of the vehicle door; and

FIG. 10 shows a graph indicating a manual force applied to a vehicle door and a corresponding position of the vehicle door, in case of a closing movement of the vehicle door.

### DETAILED DESCRIPTION

A door drive device may include an adjustment member and a drive element operatively coupled to the adjustment member such that the adjustment member is movable with respect to the drive element for moving the vehicle door relative to the vehicle body. A sensor device measures a quantity indicative of a movement of the vehicle door and/or a force acting onto the vehicle door to provide a sensor signal. A control device controls the operation of the door drive device. The control device is configured to detect, based on the sensor signal of the sensor device, an action onto the vehicle door indicative of a user command for moving the vehicle door.

The door drive device in principle may be configured as an adjusting and/or locking device and may be used to electromotively adjust the vehicle door or to mechanically lock the vehicle door in a currently assumed position. If the door drive device is configured as an electromotive adjusting device, it comprises a drive device in the form of an electric drive motor by which the vehicle door can be electromotively moved. In contrast, the door drive device may substantially act as a mechanical locking device for providing for a mechanical locking of the vehicle door in an open position, such that the vehicle door is held in position so that the vehicle door cannot easily slam shut from the open position, at least not in an uncontrolled manner.

The door drive device allows for a movement of the vehicle door by manual user action. In particular, if door drive device is controlled to allow a free manual movement, a user may act onto the vehicle door and may freely pivot the vehicle door with respect to the vehicle body in order to move the vehicle door between a closed position and a fully opened position.

If the vehicle door is partially or fully opened, the vehicle door shall be locked in a currently assumed position. If it is detected that a user acts onto the vehicle door, for example, by pushing or pulling on the vehicle door, this may indicate that the user wishes to move the vehicle door out of its currently assumed position, for example, to close the vehicle door or to further open the vehicle door. Hence, in case the control device detects such user action the control device may issue a control command to control the drive device to allow a free, manual pivoting movement of the vehicle door by the user.

Generally, external forces other than user forces will act onto a vehicle door in a regular parked position of a vehicle. For example, a pivoting axis of a vehicle door may not be perpendicular to the ground, but rather at a slanted angle such that gravity forces will act onto the vehicle door in a fully or partially opened position towards, for example, the closed position. Such external forces may cause, for example, a pretensioning of the vehicle door towards the closed position (or alternatively towards the fully opened position, depending on the setup and construction of the vehicle). Hence, if a user manually acts onto a vehicle door, the force the user may have to apply may depend on the desired movement direction of the vehicle door, depending upon whether the user acts onto the vehicle door in the same direction as pretensioning forces or in a counter direction with respect to pretensioning forces. This may cause that the user may experience a different behavior of the door system for initiating a movement of the vehicle door in an opening direction or in a closing direction, which one may wish to avoid.

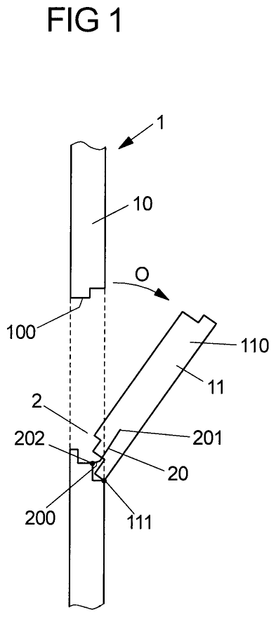

FIG. 1 shows, in a schematic view, a vehicle 1 comprising a vehicle body 10 and an adjusting element in the form of a vehicle door 11 which is arranged on the vehicle body 10 via a hinge 111 such that it can be pivoted about a pivot axis with respect to the vehicle body 10 along an opening direction O.

The vehicle door 11 may, for example, be a vehicle side door or a tailgate. In a closed position, the vehicle door 11 conceals a vehicle opening 100 in the vehicle body 10, for example, a side door opening or a tailgate opening.

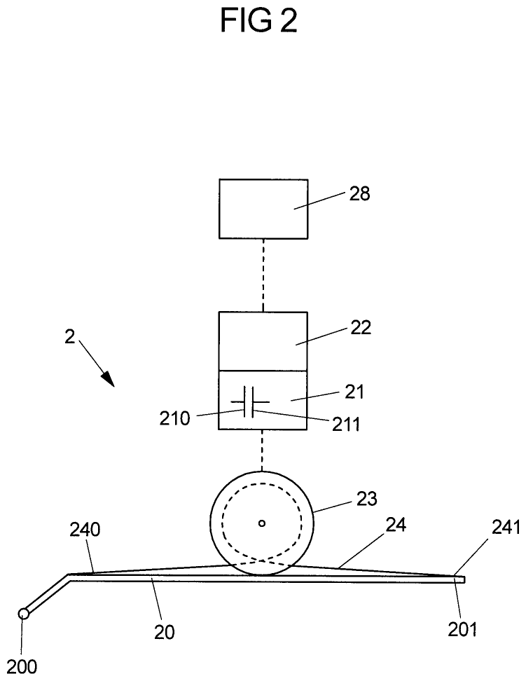

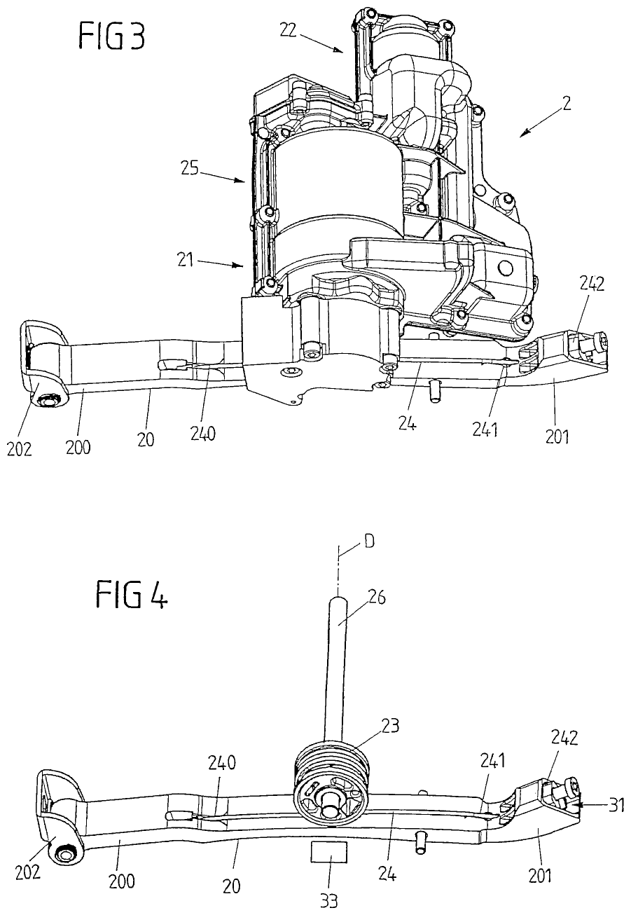

The vehicle door 11 can electromotively be moved from its closed position to an open position via a door drive device 2 arranged in a door interior 110. The door drive device 2, as schematically illustrated in FIG. 2 and as illustrated in an embodiment in FIGS. 3 to 5, includes a drive motor 22 that is coupled via a coupling device 21 to an adjustment member 20 via which adjusting forces can be transmitted between the vehicle door 11 and the vehicle body 10. In the one or more embodiments, the drive motor 22 is fixed to the vehicle door 11, while the adjustment member 20, designed in the manner of a so-called door retaining strap, is pivotably connected at an end 200 to the vehicle body 10.

In the embodiments of the door drive device 2 shown in FIGS. 2 and 3 to 5, the drive motor 22 drives a drive element 23 in the form of a cable drum which is coupled to the adjustment member 20 via a transfer element 24 in the form of a flexible traction element, in particular in the form of a traction cable (for example, a steel cable), configured to transmit (exclusively) tensile forces. The cable drum 23 may, for example, be supported on the longitudinally extended adjustment member 20 and may roll along the adjustment member 20 in order to move the adjustment member 20 relative to the cable drum 23.

The transfer element 24 is connected to the adjustment member 20 via a first end 240 in the vicinity of the end 200 of the adjustment member 20 and via a second end 241 in the vicinity of a second end 201 of the adjustment member 20, and is wound around the drive element 23 in the shape of the cable drum. When the drive element 23, driven by the drive motor 22, is rotated, the transfer element 24 in the form of the traction element (traction cable) moves relative to the drive element 23 so that the drive element 23 is moved relative to the adjustment member 20, resulting in displacement of the vehicle door 11 relative to the vehicle body 10.

It should be noted at this point that other types of power transmission arrangements are conceivable. For example, the drive motor 22 can also drive a pinion which is in meshing engagement with a tooth rack forming the adjustment member 20. Alternatively, the door drive device may be configured as a spindle drive including, for example, a rotatable spindle that engages with a spindle nut.

The coupling device 21, in one or more embodiments, serves as a coupling device to couple the drive motor 22 with the drive element 23 or to uncouple it from the drive element 23. In a coupling state, the coupling device 21 establishes a flux of force between the drive motor 22 and the drive member 23 such that a rotational movement of a motor shaft 220 of the drive motor 20 is transmitted to the drive member 23 and, consequently, the drive member 23 is set into a rotational movement to introduce an adjusting force into the adjustment member 20. In an uncoupling state, in contrast, the drive motor 22 is uncoupled from the drive element 23, so that the drive motor 22 can be moved independently of the drive element 23 and, conversely, the drive element 23 can be moved independently of the drive motor 22. In this uncoupling state, the vehicle door 11 may be manually moved with respect to the vehicle body 10 without applying a load to the drive motor 22.

The coupling device 21 may include a third state, corresponding to a brake state, in which coupling elements are in contact with each other in a braking manner. A first coupling element is operatively connected to a motor shaft of the drive motor 22, while a second coupling element is operatively connected to the drive element 23. In this brake state, the coupling device 21 provides a braking force during manual movement of the vehicle door 11, caused by a sliding, frictional contact of the coupling elements.

In the example shown in FIGS. 3 to 5, the drive motor 22 includes a motor shaft 220 that is set into a rotary motion during operation of the door drive device 2 and is operatively connected to a gear 25 (e.g. a planetary gear). A shaft 26, which is rotatable about an axis of rotation D, is driven by the gear 25 and carries the drive element 23 in the form of the cable drum, such that the drive element 23 can be driven by rotating the shaft 26, thereby causing the transfer element 24 to move with respect to the drive element 23 such that the adjustment member 20 is adjusted for moving the vehicle door 11.

The door drive device 2 includes a sensor device 27 arranged at an end of the shaft 26 opposite the drive element 23 and configured to determine, during operation, the absolute rotational position of the shaft 26. The sensor device 27 may, for example, have a magnetic disk coupled to the shaft 26 and a magnetic sensor for detecting a position of the magnetic disk.

The coupling device 21 may be electrically actuated via an actuator 210. In its coupling state, the coupling device 21 establishes a force flow between the gear 25 and the shaft 26, so that an adjusting force can be transmitted from the drive motor 22 to the shaft 26 and in this way to the adjustment member 20. In its uncoupling state, on the other hand, the coupling device 21 disrupts the force flow between the drive motor 22 and the shaft 26 so that the adjustment member 20 can be adjusted relative to the drive motor 22 without applying a force to the drive motor 22.

As schematically shown in FIG. 2, the coupling device 21 includes coupling elements 210, 211 which, in the coupling state of the coupling device 21, are in frictional abutment with one another such that forces may be transferred in between the coupling elements 210, 211. In the coupling state a force flow in between the vehicle door 11 and the vehicle body 10 is established. In the uncoupling state, in turn, the coupling elements 210, 211 are separated from one another such that the force flow in between the vehicle door 11 and the vehicle body 10 is disrupted.

In the coupling state, the coupling elements 210, 211 of the coupling device 21 may be pressed against one another at a predetermined force, such that the frictional connection in between the coupling elements 210, 211 is held at a maximum holding torque. If the maximum holding torque is exceeded, the coupling elements 210, 211 may be frictionally moved with respect to one another (under dynamic friction) such that a relative movement of the vehicle door 11 with respect to the vehicle body 10 becomes possible.

As schematically shown in FIG. 2, the operation of the drive motor 22 is controlled via a control device 28 arranged, for example, on a carrier plate of a door module of the vehicle door 11. Such a carrier element may, for example, carry different functional components of the vehicle door, such as a window regulator, a loudspeaker, a door lock or the like. In this context, the control device 28 can be used to control the door drive device 2, but also to control other functional components of the vehicle door 11.

Referring to FIGS. 1 to 5, the door drive device 2 may electromotively move the vehicle door 11 and lock the vehicle door 11 in an open position. In a locking position, the coupling device 21 is in its coupling state and establishes a force flow between the vehicle door 11 and the vehicle body 10, so that the vehicle door 11, e.g., due to a self-locking of the gear 25 and/or the drive motor 22 is held in its open position. The vehicle door 11, therefore, cannot easily, at least not in an uncontrolled manner, move out of an open position once it has been opened.

It may be desirable to enable a user to easily adjust the vehicle door 11. For this, it is to be detected when a user interacts with the vehicle door 11 in order, for example, to close the vehicle door 11 from the open position or to open it further in the opening direction θ. If a user applies a force to the vehicle door 11, for example, by pushing or pulling on the vehicle door 11, this shall be recognized as an adjustment request in order to initiate an electromotive adjustment of the vehicle door 11 or to permit a manual adjustment of the vehicle door 11 by the user.

If an adjustment request of a user is detected, the control device 28 may be configured in different ways to initiate an adjustment of the vehicle door 11 in an electromotive manner or to allow a manual adjustment of the vehicle door 11.

If the vehicle door 11 is to be adjusted by an electric motor when an adjustment request is detected, the control unit 28 controls the drive motor 22 to electromotively adjust the vehicle door 11 once an adjustment request is detected. In this case, the coupling device 21 remains in its closed (coupling) state.

If, in contrast, a manual movement of the vehicle door 11 shall be enabled when an adjustment request is detected, the control device 28 controls the coupling device 21, once an adjustment request is detected, to transfer the coupling device 21 into its free (uncoupling) state so that the force flow between the vehicle door 11 and the vehicle body 10 is disrupted and the vehicle door 11 can freely be moved manually.

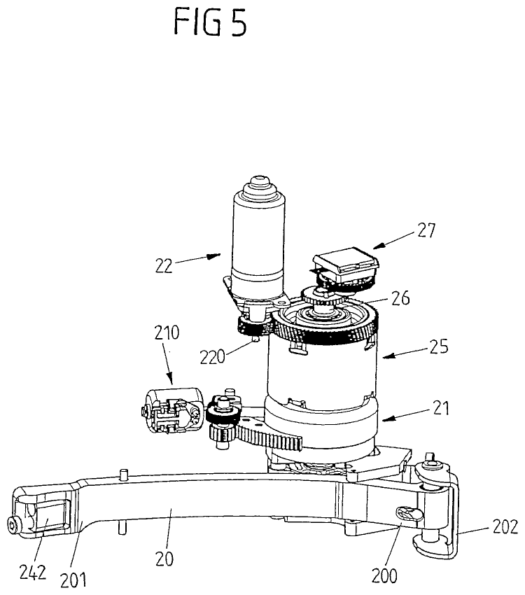

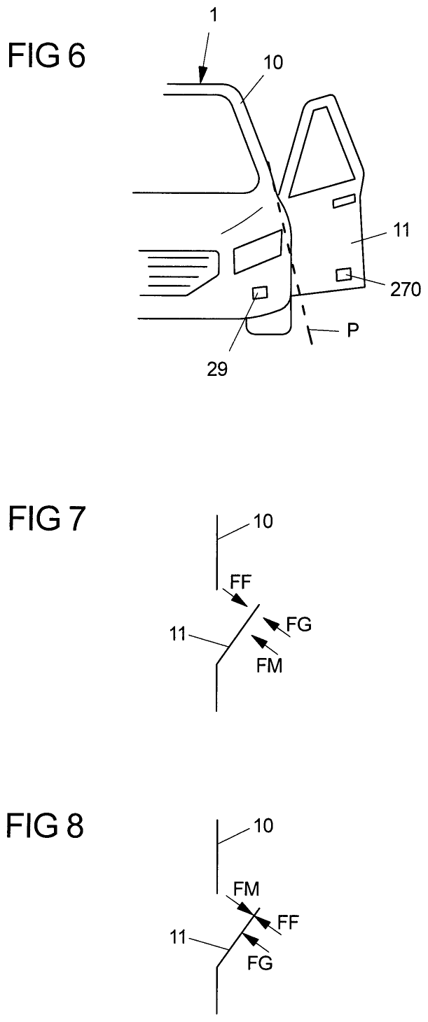

For detecting whether an adjustment request by a user is present, it shall be detected whether a user acts onto the vehicle door 11, for example, by manually pulling or pushing on the vehicle door 11 in order to move the vehicle door 11 from a fully or partially opened position, for example, towards the closed position or to a farther opened position. For deciding whether an adjustment request by a user is present, the control device 28 evaluates sensor signals of one or multiple sensors, for example, the sensor device 27 of the door drive device 2 (see FIG. 5) allowing to derive information about the current position of the vehicle door 11 and a change in position of the vehicle door 11, a speed of the vehicle door 11 and/or an acceleration of the vehicle door 11. Alternatively or in addition, sensors such as an angular velocity sensor (gyrometer) or an accelerometer placed on the vehicle door 11 (such as a sensor 270 schematically illustrated in FIG. 6) or a force sensor for measuring a force acting in between the vehicle door 11 and the vehicle body 10, for example, by observing a deformation of a component within the path of force flow in between the vehicle door 11 and the vehicle body 10, may be used. Such sensors provide sensor signals indicative of a movement of the vehicle door 11 or a force acting onto the vehicle door 11, such that from such sensor signals information may be derived from which it may be evaluated whether a user likely acts onto the vehicle door 11 for initiating a movement of the vehicle door 11.

As schematically illustrated in FIG. 6, generally a pivot axis P about which the vehicle door 11 is pivotable with respect to the vehicle body 10 is not directed along a perpendicular direction to the ground, but at a slanted angle. This has the effect that generally a gravity force will act onto the vehicle door 11 if the vehicle door 11 is fully or partially opened, the gravity force causing a pretensioning of the vehicle door 11 towards the closed position (or alternatively towards the opened position, depending on the setup and construction of the vehicle 1). Hence, generally, external forces will act onto the vehicle door 11, which cause a pretensioning on the vehicle door 11 towards one of its end positions.

This has the effect that a user who manually acts onto the vehicle door 11 for initiating a movement of the vehicle door 11 will experience a behavior of the system which depends on the movement direction of the vehicle door 11. This is due to the fact that in one direction the pretensioning forces will support the user action, whereas in the other direction the pretensioning will counteract the user action. The user may generally experience a different force required for initiating a movement of the vehicle door 11, depending on the desired movement direction.

This is illustrated in FIGS. 7 and 8. For example, a gravity force FG acts onto the vehicle door 11 towards the closed position such that a closing movement by a manual force FM is supported by the gravity force FG, a frictional holding force FF of the coupling device 21 acting against the movement of the vehicle door 11 (FIG. 7). In the opening direction, in contrast, the user exerts a manual user force FM has to act against both the gravity force FG and the frictional holding force FF supplied by the coupling device 21 (FIG. 8), the user hence generally having to apply a larger force FM in the opening direction then in the closing direction.

In order to provide for a user experience that is more uniform and more independent of the desired movement direction of the vehicle door 11, it is proposed to use different decision parameters for deciding about the presence of a user action indicative of an adjustment request, the decision parameters being variable dependent on the movement direction of the vehicle door 11.

Generally, the control device 28 evaluates sensor signals of one or multiple sensors 27, 270 for deciding an adjustment request, wherein for the decision a characteristic value derived from a sensor signal is, for example, compared to a threshold value specified by the decision parameter. As different decision parameters are used to decide about an adjustment request in the opening direction and in the closing direction, the characteristic value is, for example, compared to different thresholds dependent on the movement direction of the vehicle door 11.

The control device 28 may, for example, be configured to decide about an adjustment request by a user depending on a position criterion. If it is found that the vehicle door 11 has been moved out of its position by a distance larger than a position threshold, it is decided that an adjustment request of a user is present and accordingly the control device 28 issues a control command to switch the coupling device 21 from its coupling state to the uncoupling state or to control the drive motor 22 to electromotively move the vehicle door 11.

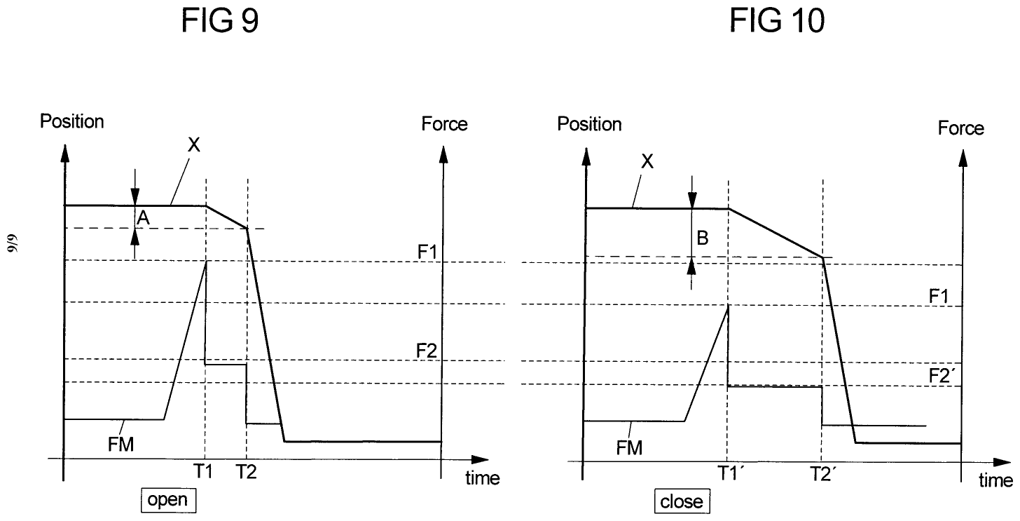

This is illustrated in FIGS. 9 and 10. It may be assumed that the vehicle door 11 currently is held in a partially opened position, the coupling device 21 being in its coupling state such that a force flow in between the vehicle door 11 and the vehicle body 10 is established and the vehicle door 11 hence is held in position.

If, as illustrated in FIG. 9, a user wishes to move the vehicle door 11 further in the opening direction, the user applies a manual force FM to the vehicle door 11, which will rise until at time T1 the maximum holding torque of the coupling device 21 is exceeded and the coupling elements 210, 211 of the coupling device 21 hence are moved with respect to each other under dynamic friction (the coupling device 21 still being in its coupling state). The position X of the vehicle door 11 changes, until at time T2 it is found that the change in position X exceeds a predefined position threshold A such that the coupling device 21 is controlled to switch to the uncoupling state at time T2 and a free pivoting movement of the vehicle door 11 at a minimum manual force FM is possible.

If, in contrast, as illustrated in FIG. 10, a user wishes to move the vehicle door 11 towards the closed position, the user applies a manual force FM to the vehicle door 11, which will rise until at time T1′ the coupling elements 210, 211 of the coupling device 21 are moved with respect to each other under dynamic friction (the coupling device 21 still being in its coupling state), the vehicle door 11 now being moved out of its currently assumed position such that the position X of the vehicle door 11 changes. At time T2′ the change in position X exceeds a threshold B such that it is decided that an adjustment request by a user is present and accordingly the coupling device 21 is switched to its uncoupling state, such that a manual movement of the vehicle door 11 at a minimum manual force FM is possible.

In comparing FIGS. 9 and 10, the manual force FM leading to a frictional movement of the coupling elements 2210, 211 with respect to each other is different (peaks at time T1 and T1′ respectively). This is due to the fact that in the opening direction the user has to act against the gravity force FG (see FIG. 8) and hence has to apply a larger force FM (corresponding to value F1), whereas in the closing direction the gravity force acts in support of the manual user force FM (see FIG. 7) and hence a smaller force FM must be applied by a user (corresponding to value F1′). Also, the manual force FM to be applied for frictionally moving the coupling elements 210, 211 of the coupling device 21 with respect to each other is different dependent on the moving direction (force values F2 and F2′, respectively).

Hence, in order to provide for a more uniform experience and feeling to the user for initiating a movement of the vehicle door 10, the position threshold A, B, in the example of FIGS. 9 and 10, is chosen differently depending on the movement direction of the vehicle door 11. In the opening direction a smaller threshold A is applied to decide for an adjustment request, whereas in the closing direction a larger threshold B is applied. Hence, in the opening direction a user has to apply a larger force, but has to move the door over a smaller distance. In the closing direction, in turn, the user has to apply a smaller force, but has to move the vehicle door 11 over a larger distance.

Dependent on the sensor signal and the information derived from the sensor signal for deciding about an adjustment request (e.g., depending on whether a position information, a velocity information, an acceleration information or a force information is used) different decision parameters (or combinations thereof), in particular different thresholds may be used, wherein in each case the decision parameter depends on the movement direction and hence is variable dependent on the movement direction.

The control device 28 may also be configured to variably set and adjust the decision parameter, taking into account e.g., information relating to additional conditions, for example, a parking position of the vehicle 1. For example, if an inclination sensor 29 (as schematically illustrated in FIG. 6) indicates that the vehicle 1 is parked at an inclined position, from information relating to the inclination it can be derived, by additionally taking, for example, the known mass of the vehicle door 11 into account, what gravity forces act onto the vehicle door 11. Dependent on this, it can be determined what pretensioning forces act towards the closed position or the opened position, such that based on this a decision parameter, e.g., an applied threshold, can be adjusted.

Also, if it is found, for example, by using a monitoring sensor such as a radar or lidar system, that a foreign object is present in the path of movement of the vehicle door 11 in a desired movement direction, it may be desired to prevent a movement of the vehicle door 11 towards the foreign object. For this, the decision parameter may be adapted in order to effectively prevent that a movement of the vehicle door 11 towards the foreign object can be initiated.

This invention is not limited to the embodiments described above, but can also be implemented in a completely different way.

For example, a door drive may include a mechanical adjustment mechanism other than a cable drive, for example, a pinion gear for coupling a drive motor to an adjustment member. Alternatively, the door drive can be configured as a spindle drive, in which, for example, a rotatable spindle engages with a spindle nut such that the spindle nut may be moved along the spindle by rotary movement of the spindle.

In the case of a mechanical locking device, a drive motor possibly is not present in the door drive device.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

List of reference numerals

| | |
|---|---|
| 1 | vehicle |
| 10 | vehicle body |
| 100 | vehicle opening |
| 11 | vehicle door |
| 110 | door interior |
| 111 | door hinge |
| 2 | door drive device |
| 20 | adjustment member |
| 200, 201 | end |
| 202 | hinge |
| 21 | coupling device |
| 210 | actuator |
| 210, 211 | coupling element |
| 22 | drive motor |
| 220 | motor shaft |
| 23 | drive element |
| 24 | transfer element (pull cable) |
| 240, 241 | end |
| 25 | gear |
| 26 | shaft |
| 27 | sensor device |
| 270 | sensor device |
| 28 | control device |
| 29 | sensor device |
| A, B | release threshold |
| D | axis of rotation |
| F1, F2, F1′, F2′ | force |
| FF | brake force |
| FG | gravity force |
| FM | manual force |
| O | opening direction |
| P | pivot axis |
| t | time |
| X | door position |

1. A door drive device for adjusting and/or locking a vehicle door relative to a vehicle body, the door drive device comprising:
an adjustment member;
a drive element operatively coupled to the adjustment member such that the adjustment member is movable with respect to the drive element for moving the vehicle door relative to the vehicle body;
a sensor configured to measure a movement of the vehicle door and/or a force acting onto the vehicle door and to output a sensor signal; and
a control device configured to control operation of the door drive device, the control device being programmed to:
detect an action onto the vehicle door indicative of a user command for moving the vehicle door based on the sensor signal, and
conclude for an action onto the vehicle door indicative of a user command for moving the vehicle door by evaluating a characteristic value derived from the sensor signal based on a decision parameter, wherein the decision parameter is variable depending on a movement direction of the vehicle door.

2. The door drive device of claim 1, wherein the control device is further programmed to derive from the sensor signal, as the characteristic value, information indicative of at least one of the position of the vehicle door, a movement speed of the vehicle door, an acceleration of the vehicle door, and a force acting onto the vehicle door.

3. The door drive device of claim 1, wherein the control device is further programmed evaluate the characteristic value by comparing the characteristic value to the decision parameter.

4. The door drive device of claim 1, wherein the control device is further programmed to set the decision parameter to a first value for an opening movement of the vehicle door and to a second value, that is different from the first value, for a closing movement of the vehicle door.

5. The door drive device of claim 1 further comprising a second sensor configured to output a second sensor signal, and wherein the control device is further programmed to adjust the decision parameter based on at least the second sensor signal.

6. The door drive device of claim 5, wherein the second sensor signal is indicative of a gravity force acting onto the vehicle door.

7. The door drive device of claim 6, wherein the second sensor signal is indicative of an object in a movement path of the vehicle door.

8. The door drive device of claim 1 further comprising a coupling device operatively connected to the drive element, wherein the coupling device is actuatable between a coupling state that establishes a force flow between the vehicle door and the vehicle body via the drive element and the adjustment member, and an uncoupling state that allows free pivoting of the vehicle door with respect to the vehicle body.

9. The door drive device of claim 8, wherein the control device is further programmed to switch the coupling device between the coupling state and the uncoupling state based on the detection.

10. The door drive device of claim 9, wherein the coupling device includes coupling elements that are in frictional connection with each other when in the uncoupling state and are released from one another when in the uncoupling state.

11. The door drive device of claim 10, wherein the coupling elements, when in the coupling state, are configured to be frictionally movable with respect to each other when a torque larger than a maximum holding torque is applied in between the coupling elements.

12. The door drive device of claim 11, wherein the control device is further programmed to adjusting the maximum holding torque.

13. The door drive device of claim 1 further comprising an electric drive motor configured to drive the drive element.

14. (canceled)

15. A method for operating a door drive device for adjusting and/or locking a vehicle door relative to a vehicle body, the method comprising:
moving an adjustment member with respect to a drive element for moving the vehicle door relative to the vehicle body;
measuring, using a sensor device, a measuring quantity indicative of a movement of the vehicle door and/or a force acting onto the vehicle door to provide a sensor signal;
controlling, using a control device, operation of the door drive device;
detecting an action onto the vehicle door indicative of a user command for moving the vehicle door based on the sensor signal; and
including for an action onto the vehicle door indicative of a user command for moving the vehicle door by evaluating a characteristic value derived from the sensor signal based on a decision parameter.

16. The method of claim 15, wherein the decision parameter is variable depending on a movement direction of the vehicle door.

17. The method of claim 15 further comprising:
deriving from the sensor signal, as the characteristic value, information indicative of at least one of a position of the vehicle door, a movement speed of the vehicle door, an acceleration of the vehicle door, and a force acting onto the vehicle door.

18. The method of claim 15 further comprising:
evaluating the characteristic value by comparing the characteristic value to the decision parameter.

19. The method of claim 15 further comprising:
setting the decision parameter to a first value for an opening movement of the vehicle door and to a second value, that is different from the first value, for a closing movement of the vehicle door.

20. The method of claim 15 further comprising:
measuring, using a second sensory, gravity force acting on the vehicle door; and
adjusting the decision parameter based on at least the gravity force acting on the vehicle door.
